(19) United States
(12) Patent Application Publication
(10) Pub. No.: US 2015/0279501 A1
(43) Pub. Date: Oct. 1, 2015

(54) TRANSPARENT CONDUCTIVE FILM HAVING IMPROVED VISIBILITY AND METHOD FOR MANUFACTURING SAME

(71) Applicant: LG HAUSYS, LTD., Yeongdeungpo-gu Seoul (KR)

(72) Inventors: Keun Jung, Yongin-si (KR); In-Sook Kim, Gunpo-si (KR); Min-Hee Lee, Gunpo-si (KR); Jung Cho, Seoul (KR); Kyung-Taek Kim, Bucheon-si (KR)

(21) Appl. No.: 14/435,591

(22) PCT Filed: Oct. 15, 2013
(86) PCT No.: PCT/KR2013/009214

§ 371 Date: Apr. 14, 2015

(30) Foreign Application Priority Data
Oct. 16, 2012 (KR) 10-2012-0114915

(51) Int. Cl. H01B 1/08; H01B 13/00

(52) U.S. Cl. CPC H01B 1/08; H01B 13/0026

(57) ABSTRACT

The present invention relates to a transparent conductive film having improved visibility and, more specifically, to a transparent conductive film capable of improving pattern visibility by including inorganic particles in an undercoating layer so as to increase a refractive index of the undercoating layer and a method for manufacturing the same. The undercoating layer in a transparent conductive film of the present invention exhibits a refractive index that is higher than that of a silicon oxide layer formed by using a sputtering technique and is lower than that of a transparent conductive layer such that excellent pattern visibility can be obtained, and is formed by using a stable high-speed production method such that uniform thickness in the width direction can be obtained.

### TECHNICAL FIELD

The present invention relates to a transparent conductive film exhibiting improved visibility. More particularly, the present invention relates to a transparent conductive film, which can exhibit improved pattern visibility by forming an undercoating layer including inorganic particles to have an increased index of refraction, and a method for manufacturing the same.

### BACKGROUND ART

A transparent electrode film is one of the most important components in manufacture of touch panels. As the transparent electrode film, an indium tin oxide (ITO) film having a total light transmittance of 85% or more and a surface resistance of 400 Ω/square or less is most widely used in the related art.

General transparent electrode films use a polymer film, which is subjected to primer coating and hard coating to impart surface flatness and heat resistance thereto, as a base film.

On the base film, a transparent undercoating layer is formed by wet coating or vacuum sputtering, followed by forming a transparent conductive layer such as ITO by sputtering.

Recently, with increasing use of capacitive touch panels, there is a need for realization of a low surface resistance of less than 200 Ω/square for minute-constant current and improvement in visibility of patterns of transparent conductive films.

### DISCLOSURE

### Technical Problem

It is one aspect of the present invention to provide a transparent conductive film capable of securing improved pattern visibility by inclusion of an inorganic particle-containing undercoating layer, which is formed by wet coating and has a suitable index of refraction between that of a substrate and that of a conductive layer to allow patterns of a conductive layer to be hidden.

It is another aspect of the present invention to provide a method for manufacturing the transparent conductive film as set forth above.

### Technical Solution

In accordance with one aspect of the present invention, a transparent conductive film includes: a transparent film; an undercoating layer formed on the transparent film; and a conductive layer formed on the undercoating layer, wherein the undercoating layer includes inorganic particles, and a difference in index of refraction between the undercoating layer and the transparent film ranges from 0.15 to 0.30.

In accordance with another aspect of the present invention, a method for manufacturing a transparent conductive film includes: forming an undercoating layer by wet-coating a composition for coating onto a transparent film; and forming a conductive layer on the undercoating layer, wherein the composition for coating includes inorganic particles.

### Advantageous Effects

According to the present invention, the undercoating layer of the transparent conductive film has an index of refraction higher than that of a silicon oxide layer formed by sputtering and lower than that of a transparent conductive layer to secure excellent pattern visibility, can be formed in a stable high-speed production method, and can easily secure thickness uniformity in width and length directions.

In addition, since only the conductive layer is formed by sputtering, the method according to the present invention can improve a production rate by two times or more, as compared with a typical method in which a portion of the undercoating layer is formed by sputtering, and thus can facilitate mass production of the transparent conductive film.

### DESCRIPTION OF DRAWINGS

FIG. 1 is a sectional view of a transparent conductive film according to one embodiment of the present invention.

### BEST MODE

The above and other aspects, features, and advantages of the present invention will become apparent from the detailed description of the following embodiments in conjunction with the accompanying drawings. However, it should be understood that the present invention is not limited to the following embodiments and may be embodied in different ways, and that the embodiments are provided for complete disclosure and thorough understanding of the invention by those skilled in the art. The scope of the invention should be defined only by the accompanying claims and equivalents thereof.

In the drawings, thicknesses of various layers and regions are enlarged for clarity, and thicknesses of some layers and regions are exaggerated for convenience. It will be understood that when an element such as a layer, film, region or substrate is referred to as being placed “on” another element, it can be directly placed on the other element, or intervening layer(s) may also be present.

Hereinafter, a transparent conductive film and a method for manufacturing the transparent conductive film according to the present invention will be described in detail with reference to the accompanying drawings.

Transparent Conductive Film

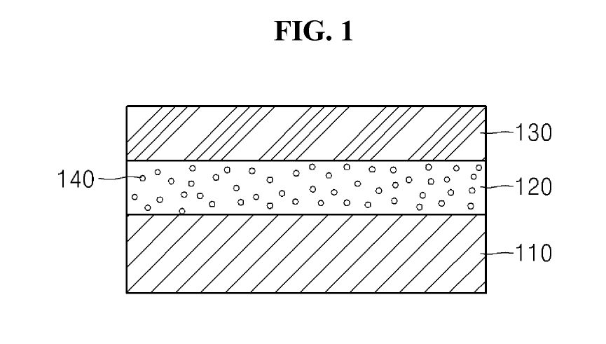

FIG. 1 shows a schematic sectional view of a transparent conductive film according to one embodiment of the present invention. The transparent conductive film according to this embodiment includes a transparent film 100, an undercoating layer 120, and a conductive layer 130.

Since the conductive layer 130 is formed in a predetermined pattern, the transparent conductive film can secure excellent pattern visibility only when the pattern is hidden. Highly refractive properties of the undercoating layer 120 allow the pattern of the conductive layer 130 to be hidden and thus allow the transparent conductive film to secure excellent pattern visibility. The transparent film 110 may be a film exhibiting excellent transparency and strength. A material of the transparent film 110 may include polyethylene terephthalate (PET), polyethylene naphthalate (PEN), polyethersulfone (PES), polycarbonate (PC), polypropylene (PP), norbornene resins, and the like. These materials may be used alone or in combination thereof. In addition, the transparent film 110 may be a monolayer or multilayer film.

The undercoating layer 120 serves to improve adhesion and transmittance between the transparent film 110 and the conductive layer 130. Considering that the conductive layer 130 has an index of refraction of about 1.9 to about 2.0, it is advantageous that a difference in index of refraction between the transparent film 110 and the undercoating layer 120 is in a suitable level to reduce a difference in reflectance. Advantageously, the difference in index of refraction ranges from 0.15 to 0.30, preferably from 0.20 to 0.25. Since silicon oxide (SiO₂) generally used for the undercoating layer merely has an index of refraction of about 1.45, inorganic particles 140 are used to obtain an index of refraction of the undercoating layer which is suitable for the transparent films.

The undercoating layer 120 may be formed in a single layer, and aims at securing pattern visibility while being capable of being formed by wet coating which is a relatively simple process. The inorganic particles 140 may include at least one selected from among ZnO, TiO₂, CeO₂, SnO₂, ZrO₂, MgO, and Ta₂O₅. Preferably, the inorganic particles 140 are ZrO₂ or TiO₂. When the inorganic particles have a particle size of 5 nm to 100 nm, preferably 10 nm to 40 nm, the undercoating layer 120 has an advantage in securing a suitable index of refraction and uniformity of optical properties and in controlling thickness thereof.

The undercoating layer 120 may include the inorganic particles 140 in an amount of 0.1% by weight (wt %) to 10 wt %, specifically 0.5 wt % to 8 wt %. When the undercoating layer 120 includes the inorganic particles 140 within this range, the undercoating layer 120 can realize a desired level of pattern visibility as a single layer by wet coating while realizing a similar index of refraction to that of the conductive layer 130.

Although the undercoating layer 120 may be silicon oxide (SiO₂) as typically used in the art, the undercoating layer 120 is preferably a photocurable compound. The photocurable compound may be a monomer or oligomer having at least one functional group, such as an unsaturated bonding group capable of crosslinking The monomer or oligomer having at least one functional group may include urethane acrylate, epoxy acrylate, polyether acrylate, polyester acrylate, dipentaerythritol hex aacrylate, dipentaerythritolpentaacrylate, pentaerythritol tetraacrylate, dipentaerythritol hexaacrylate, dipentaerythritol pentaacrylate, and the like.

As described above, the undercoating layer 120 containing the inorganic particles 140 has an index of refraction from 1.45 to 1.80.

In addition, the undercoating layer 120 has a thickness of 10 nm to 500 nm, preferably 40 nm to 300 nm, more preferably 50 nm to 100 nm. If the thickness of the undercoating layer 120 is greater than 500 nm, the undercoating layer suffers from rainbow spots due to multilayer film interference without improvement in optical properties and has a problem of increased manufacturing cost, and if the undercoating layer 120 is formed to a thin thickness of less than 10 nm, the undercoating layer has a difficulty in securing a uniform thickness and suffers from deterioration in transmittance and visibility. The conductive layer 130 is formed on the undercoating layer 120 and may be formed of indium tin oxide (ITO), fluorine-doped tin oxide (FTO) or the like, which exhibits excellent transparency and conductivity. The conductive layer 130 may have a thickness of 15 nm to 40 nm. If the thickness of the conductive layer is greater than 40 nm, the conductive layer exhibits reduced transmittance and has a problem of exhibiting a color, and if the thickness of the conductive layer is less than 15 nm, the conductive layer has a problem of increase in resistance.

Method for Manufacturing Transparent Conductive Film

In accordance with another aspect of the present invention, a method for manufacturing a transparent conductive film includes: forming an undercoating layer by wet-coating a composition for coating onto a transparent film; and forming a conductive layer on the undercoating layer, wherein the composition for coating includes inorganic particles.

The undercoating layer 120 is formed by wet coating the composition for coating, followed by heat treatment. In addition, the composition for coating includes the inorganic particles, whereby the undercoating layer 120 includes the inorganic particles 140.

As described above, the inorganic particles 140 may include at least one selected from among ZnO, TiO₂, CeO₂, SnO₂, ZrO₂, MgO, and Ta₂O₅. Preferably, the inorganic particles 140 are ZrO₂ or TiO₂.

In addition, the composition for coating may be prepared by mixing a photocurable compound, a photopolymerization initiator and the inorganic particles, and when the composition includes the photocurable compound, the undercoating layer may be formed by polymerization of the composition through irradiation with ultraviolet light, electron beams, and the like.

The composition for wet coating may include a solvent to facilitate dispersion. The solvent may include water, organic solvents, and mixtures thereof. The organic solvents may include alcohols, halogen-containing hydrocarbons, ketones, cellosolve, amide solvents, and the like. More specifically, the alcohol solvents include methanol, ethanol, isopropyl alcohol, n-butanol, diacetone alcohol, and the like; the halogen-containing hydrocarbon solvents include chloroform, dichloromethane, ethylene dichloride, and the like; the ketone solvents include acetaldehyde, acetone, methyl ethyl ketone, methyl isobutyl ketone, and the like; cellosolve solvents include methyl cellosolve, isopropyl cellosolve, and the like; and the amide solvents include dimethylformamide, formamide, acetamide, and the like.

Wet coating may be performed by one method selected from among gravure coating, slot die coating, spin coating, spray coating, bar coating, and dip coating. Preferably, gravure coating or slot die coating is used.

As described above, the undercoating layer 120 is formed to a thickness of 10 nm to 500 nm, preferably 40 nm to 300 nm, more preferably 50 nm to 100 nm.

In addition, the conductive layer 130 may be formed of ITO or FTO on the undercoating layer 120. Preferably, the conductive layer 130 is formed by DC power reactive sputtering using an ITO target. Here, a b* value on a colorimeter is adjusted by adjustment of oxygen partial pressure, whereby pattern visibility can be further improved.

Hereinafter, the present invention will be explained in more detail with reference to some examples.

It should be understood that these examples are provided for illustration only and are not to be construed in any way as limiting the present invention.

### EXAMPLE

0.5 parts by weight of TiO₂ particles having an average particle diameter of 30 nm, 0.5 parts by weight of ZrO₂ having the same average particle diameter, and 0.5 parts by weight of a photopolymerization initiator were mixed with 100 parts by weight of a urethane acrylate binder, followed by dilution in methylethylketone, thereby preparing a composition for formation of an undercoating layer.

On an undercoating layer, which was formed to a thickness of 60 nm by coating the composition onto a rear surface of a 125 μm thick PET film using gravure coating, followed by UV curing, an ITO layer was formed to a thickness of 20 nm by DC power reactive sputtering using an ITO target, thereby manufacturing a final conductive film.

When the composition for formation of an undercoating layer was formed into a film having a thickness 2 μm or more, the undercoating layer had an index of refraction of 1.55 as measured using a prism coupler.

### Comparative Example

A silicon oxide thin film was formed to a thickness of 20 nm as an undercoating layer on a rear surface of a 125 μm thick PET film by DC power reactive sputtering, followed by heat treatment. Next, an ITO layer was formed to a thickness of 20 nm on the silicon oxide thin film by DC power reactive sputtering using an ITO target, thereby manufacturing a final conductive film.

When the silicon oxide thin film was formed to a thickness of 2 μm or more, the undercoating layer had an index of refraction of 1.45, as measured using a prism coupler.

### Evaluation (Comparison of Optical Properties)

Each of the transparent conductive films of Example and Comparative Example was evaluated as to optical properties such as total light transmittance of the undercoating layer, color, and pattern visibility. Results are shown in Table 1. Total light transmittance and transmissive b* were measured using a spectrophotometer. In addition, pattern visibility was evaluated by fabricating a transparent electrode pattern through etching of only a portion of the ITO layer, followed by observation with the naked eye.

TABLE 1

| | Index of | Total light | | |
|---|---|---|---|---|
| Transparent | refraction of | transmit- | Transmis- | Pattern |
| conductive film | undercoating layer | tance (%) | sive b* | visibility |
| Example | 1.55 | 89 | 0.9 | Excellent |
| Comparative | 1.45 | 89 | 1.5 | Poor |
| Example | | | | |

As shown in Table 1, the transparent conductive film of Comparative Example, in which the undercoating layer was formed only of silicon oxide by sputtering, had a low index of refraction and a similar total light transmittance to that of the transparent conductive film of Example. However, the transparent conductive film of Comparative Example exhibited a relatively yellow color and did not exhibit improved pattern visibility. On the other hand, it could be confirmed that the transparent conductive film including the undercoating layer formed by wet coating of the inorganic particle-containing coating liquid as in Example exhibited improved pattern visibility since the undercoating layer had an index of refraction between that of the transparent film substrate and that of the transparent electrode layer.

Although the present invention has been described with reference to some embodiments in conjunction with the accompanying drawings, it should be understood that the embodiments are provided for illustrative purposes only, and that various modifications, changes, alterations, and equivalent embodiments can be made by those skilled in the art without departing from the spirit and scope of the invention. Therefore, the scope of the invention should be limited only by the accompanying claims and equivalents thereof.

### List of Reference Numerals

110: Transparent film

120: Undercoating layer

130: Conductive layer

140: Inorganic particles

1. A transparent conductive film comprising:
a transparent film;
an undercoating layer formed on the transparent film; and
a conductive layer formed on the undercoating layer,
wherein the undercoating layer comprises inorganic particles, and a difference in index of refraction between the undercoating layer and the transparent film ranges from 0.15 to 0.30.

2. The transparent conductive film according to claim 1, wherein the inorganic particles comprise at least one selected from among ZnO, TiO₂, CeO₂, SnO₂, ZrO₂, MgO, and Ta₂O₅.

3. The transparent conductive film according to claim 1, wherein the undercoating layer has an index of refraction of 1.45 to 1.80.

4. The transparent conductive film according to claim 1, wherein the undercoating layer has a thickness of 40 nm to 500 nm.

5. The transparent conductive film according to claim 1, wherein the undercoating layer is composed of a single layer.

6. The transparent conductive film according to claim 1, wherein the undercoating layer comprises 0.1 wt % to 10 wt % of the inorganic particles.

7. The transparent conductive film according to claim 1, wherein the transparent film is a monolayer or multilayer film formed of at least one of polyethylene terephthalate (PET), polyethylene naphthalate (PEN), polyethersulfone (PES), polycarbonate (PC), polypropylene (PP), and norbornene resins.

8. The transparent conductive film according to claim 1, further comprising:
a hard coating layer formed on one surface or both surfaces of the transparent film.

9. The transparent conductive film according to claim 1, wherein the conductive layer comprises at least one oxide selected from among indium tin oxide (ITO) and fluorine-doped tin oxide (FTO).

10. A method for manufacturing a transparent conductive film, comprising:
forming an undercoating layer by wet-coating a composition for coating onto a transparent film; and
forming a conductive layer on the undercoating layer,
wherein the composition for coating comprises inorganic particles.

11. The method according to claim 10, wherein wet coating is performed by one method selected from among gravure coating, slot die coating, spin coating, spray coating, bar coating, and dip coating.

12. The method according to claim 10, wherein the composition for coating comprises a photocurable compound and a photopolymerization initiator.

13. The method according to claim 10, further comprising: a hard coating layer on one surface or both surfaces of the transparent film.
